(19) United States
(12) Patent Application Publication
(10) Pub. No.: US 2026/0195509 A1
(43) Pub. Date: Jul. 9, 2026

(54) METHOD FOR CREATING CONTAINER DESIGNS AND CONTAINERS

(71) Applicant: KRONES AG, Neutraubling (DE)

(72) Inventors: Robert AUST, Illkofen (DE); Tobias WEITZER, Burglengenfeld (DE)

(21) Appl. No.: 19/445,091

(22) Filed: Jan. 9, 2026

(30) Foreign Application Priority Data
Jan. 9, 2025 (DE) 102025100598.2

(51) Int. Cl. G06F 30/27; G06F 30/17; G06F 113/20; G06F 119/18

(52) U.S. Cl. CPC G06F 30/27; G06F 30/17; G06F 2113/20; G06F 2119/18

(57) ABSTRACT

Disclosed is a method for designing containers, and in particular plastic containers and in particular beverage containers, wherein a plurality of physical parameters characteristic of a container to be designed are taken into account, wherein an artificial intelligence is used for at least one step of the method, and wherein at least some of these physical parameters are provided to this artificial intelligence as initial training data.

### CROSS REFERENCE TO RELATED APPLICATION

This application claims priority to German Patent Application Serial No. 10 2025 100 598.2, filed January 9, 2025, the contents of which are incorporated herein by reference.

### BACKGROUND OF THE INVENTION

The present invention relates to a method for creating container designs, and to a container created using this method. A wide range of containers, including a wide range of plastic containers, are known from the prior art. These also have very different designs. When conceiving such container designs, many factors must be taken into account - for example, that the container has sufficient stability.

In the creation of container designs, in particular PET containers and plastic containers in general, a variety of technologies and methods are currently used, which are constantly being further developed.

For the purposes of this application, the term "containers" refers to both finished containers and semi-finished products, such as, in particular, plastic preforms, from which plastic containers can be manufactured, in particular by blow-molding processes. These types of plastic preforms are usually manufactured using injection-molding machines. These plastic preforms already have a fully formed mouth area, usually with a thread, and a main body that is expanded by a blow-molding process.

CAD systems allow developers to create 3-D models of containers and simulate them before they go into production. This makes it possible to identify and, if necessary, solve problems in advance and to ensure that the design meets the requirements.

By using rapid prototyping methods such as stereolithography (SLA) and fused deposition modeling (FDM), developers can quickly create and test prototypes of containers. This accelerates the development process and makes it possible to implement changes quickly.

Sustainability is also an important factor in the manufacture of PET containers. Designers should consider the influence of container weight and the use of recycled (PET) material on the processability and performance or properties of the container during use.

In addition, the stability of the container, in particular its stackability and pressure resistance, is an important factor, in particular when using carbonated beverages.

US 2021 036 5614 A1 discloses a computer-implemented method, wherein a design proposal is generated using a machine learning model.

DE 10 2022 122 882 A1 describes that production data of a container and performance data are linked. A model is used to establish a relationship between production data and performance data.

DE 10 2021 133 483 A1 discloses a method for forming an exterior design using a learning agent. In this process, a user-created design is modified by a generative adversarial network, and a proposal is created which can then be accepted by a user.

Although the technologies and methods mentioned above offer many advantages, there are also some disadvantages. Prototyping methods can be expensive if they are intended to cover many different variants.

The design of containers (including plastic preforms) can be a long and complex process, in particular when it comes to reviewing design changes and simulations.

CAD systems and automated processes can limit the designer's creativity, since they can create only certain types of designs.

Nowadays, there are many different processes, machine types, customer specifications, etc., that need to be taken into account. This makes it almost impossible for a designer to consider all essential aspects in the container design process, since they no longer have all the necessary information available.

The present invention is therefore based on the object of providing a concept and/or a method which facilitate the creation of container designs, in particular of plastic containers. The aim is to create a way to take into account a wide variety of factors.

### Summary of the Invention

In a method according to the invention for designing containers, and in particular plastic containers and in particular beverage containers, a plurality of physical parameters characteristic for the designing of the container are taken into account.

According to the invention, an artificial intelligence (AI) is used for at least one method step of the method, wherein at least some of these physical parameters are provided to this artificial intelligence (AI) as initial training data.

Preferably, the container is a container that has a bottom portion which forms a standing surface for this container. Preferably, the container has a main body that is suitable and intended for forming an internal volume which is intended to receive a liquid to be received by the container. The container particularly preferably has a mouth area, which preferably constitutes the only opening of this container.

In a further method, the container is a plastic preform. This also has a mouth area and, adjoining this mouth area, a main body, which can be expanded by a processing operation, in particular a blow-molding process and in particular a stretch blow-molding process. Preferably, this plastic preform has a base dome, and in particular a base dome which is hemispherical in shape. Particularly preferably, the plastic preform is an injection-molded part. The plastic preform is particularly preferably made of PET. However, it would also be conceivable that the plastic preform be made of other plastic materials or perhaps of a fiber-based material such as in particular, but not exclusively, pulp.

A thread, and in particular an external thread, is particularly preferably arranged at this mouth area, by which a container closure can be screwed onto the container. In particular, the container is a plastic container and in particular a PET container. However, the invention would also be applicable to glass containers.

In a further preferred method, the container designed or to be designed has reinforcing elements in the bottom portion which increase the stability of the bottom portion. Preferably, at least one of these reinforcing elements, and preferably several of these reinforcing elements, are ribs which extend outwards in a radial direction of the bottom portion.

In a further preferred embodiment, containers are designed whose wall thickness varies in at least one portion of the containers. In a further preferred method, reinforcing elements and/or reinforcing ribs are also provided in the region of the main body of the container.

Preferably, in particular by using artificial intelligence, result data are output that are characteristic of a conceived design. This could include, for example, geometric data such as the height and a cross-section and/or a cross-sectional profile of the designed container. In addition, the result data may also include, for example, the shape of the main body of the container and/or the shape of the bottom of the container, or data characteristic of these.

In a further preferred method, limit ranges for the result data are output. For example, a range can be specified for the height of the container to be designed.

It is also possible to predetermine a range for the height or cross-section of a plastic preform to be designed. In addition, the wall thickness of a plastic preform can also be predetermined. In addition, by designing a plastic preform it can also be predetermined which container or plastic bottle is to be manufactured from this plastic preform.

In addition, other data relevant to the plastic preform could be predetermined, such as a design of its support ring (e.g., its thickness or diameter) or a design of a thread of the plastic preform (e.g., a height of the thread or a thread pitch).

Furthermore, it would be possible to output an image of a proposed container design (both of a plastic bottle and a plastic preform) as result data. For example, a wireframe model of a proposed container design can be output. It is also possible to output a design enriched with data - for example, with information about wall thickness and the like.

It can also be output which data were used during creation and possibly how different data were weighted.

Furthermore, it would be possible as part of the output of the result data or the result values for several suggestions for container designs to be output. It is possible to specify the properties that distinguish these multiple output container designs.

Preferably, value ranges are output for the result data or result values. For example, it can be output that the designed container should have a length between 20 cm and 23 cm and/or a diameter between 8 cm and 10 cm. In addition, a result value could be output such as that the designed container should have between five and six standing feet. Such result data or results values can also be output for a plastic preform. For example, it can be predetermined that the designed plastic preform shall have a length between 3 cm and 15 cm and an inner diameter between 1 cm and 3 cm. It is also possible to predetermine result values for the wall thickness of the plastic preform.

Preferably, result data are correlated with each other. For example, it can be specified that a container of a certain height should have a certain cross-section, or that its cross-section should lie within a certain range.

An AI or machine learning can be used in the design of plastic containers, and in particular PET containers, for one or several process steps. It is intended that several and in particular all relevant data relating to the container, including other customer objects or customer data such as a plastic preform, the labels, the closures or the filling products, the machines used, customer specifications, etc., be stored, in particular, in a structured manner. These data are provided to the AI, at least in part, as training data. When designing a plastic preform, relevant data can also be provided, such as data concerning the plastic bottle that is to be formed from this plastic preform, or material properties of the plastic preform.

Preferably, a user can select which data are made available to the AI and/or a model generation device. However, the AI can also make suggestions about which data should be provided.

In a preferred method, data are first collected from existing containers, and in particular PET containers, which are or have been processed, for example, on a filling line (in particular also an injection-molding machine). Preferably, these data are selected from a group of data that includes geometric properties of the container, such as size, shape, and wall thickness. Performance data such as speed, orientation, and failure rates can also be determined.

In this process, data relating to the containers are preferably determined using measuring devices and/or measuring systems. This may include, for example, optical measuring devices that measure data about the containers, such as a (in particular spatially resolved) wall thickness or a transparency. It is also preferably possible to predetermine certain data, such as a volume of the container or a filling product. In addition, data such as a desired weight of the empty container can also be predetermined. These measurements can be taken on both molded containers and also plastic preforms.

Preferably, a machine learning model is developed using the collected data, which can predict the relationship between the properties of the container, its performance on a filling line, and/or the machines to be used.

This can be done, for example, by using regression algorithms or neural networks. The developed machine learning model is preferably used in order to be employed in the design of containers, and in particular PET containers, in the various process steps.

An artificial intelligence (AI) can also be implemented or used by neural networks and the like. Particularly preferably, at least one image taken by an image recording device or a value taken by a measuring device or a plurality of values taken by a measuring device are evaluated. It is possible to create an image evaluation model of machine learning and/or a machine learning model.

Preferably, the image evaluation model of machine learning and/or the machine learning model is based upon an (artificial) neural network. The neural network is preferably formed as a deep neural network (DNN), in which the parameterizable processing chain has a plurality of processing layers, and/or a so-called convolutional neural network (CNN) and/or a recurrent neural network (RNN).

Preferably, the data (to be processed), in particular the spatially resolved images (or data derived from them) or other measurement data such as specific wall thicknesses or customer specifications or data relating to a starting material of the plastic preforms, are supplied in the form of input variables to the image evaluation model and/or the machine learning model or the (artificial) neural network.

The image evaluation model and/or the machine learning model or the artificial neural network preferably maps the input variables onto output variables on the basis of a parameterizable processing chain.

Particularly preferably, one or several characteristic value(s), such as in particular a target material thickness, a height, a diameter, the progression of a contour of the bottom, a geometric shape of the thread, positions and configurations of reinforcing elements in the bottom portion and/or the main body, number of standing feet of the container, the geometric shape of standing feet, or the like, is or are selected as output variable for a designed container or on the basis of the design.

Alternatively, an image of a container or part thereof can be generated as the output variables.

The machine learning image evaluation model and/or the machine learning model is/was preferably trained using predetermined training data, wherein the parameterizable processing chain is preferably parameterizable through the training.

In a preferred method, training data are used in the training process of the image evaluation model and/or the machine learning model, which comprise a plurality of spatially resolved images and/or measured values of possible containers or sections of containers, recorded by the at least one image recording device.

In a preferred method, training data are used in the training process of the image evaluation model and/or the machine learning model, which include specifications relating to a processing process of the container, such as a material of the plastic preforms used to manufacture the plastic containers, a recycled content of a material of the plastic preforms used to manufacture the plastic containers, a volume of the container to be manufactured, a weight of the plastic container to be manufactured, a height or diameter of the plastic container to be manufactured, and the like.

In addition, training data relating to the manufacturing process of the plastic preforms can also be used, such as injection pressures or temperatures used, or geometries of injection molds used.

In a preferred method, training data are used in the training process of the image evaluation model and/or the machine learning model, which take into account customer requirements, such as an approximate desired shape of the container to be manufactured.

In a preferred method, training data are used in the training process of the image evaluation model and/or the machine learning model which are characteristic for post-processing operations on the container to be designed.

This offers the advantage that a specific target design for a container to be achieved is agreed upon during the training process, and thereby for example specific characteristics of the desired container, such as a desired height, a desired bottom design, a desired labeling, a desired printing, etc., can be taken into account.

Preferably, the spatially resolved images or other data intended for use as training data (taken by at least one image recording device or recorded by another measuring device) are provided with at least one classification feature and preferably with several classification features.

In addition, other data such as customer specifications or data characteristic of subsequent processing of the plastic containers, or data characteristic of the manufacturing process of the plastic containers, can also be assigned classification characteristics.

Preferably, the (spatially resolved) images and/or values measured by measuring devices are stored and/or used together with other data, i.e., data which are characteristic of a subsequent processing of the containers and/or a material to be processed and/or a processing process, as classification feature(s) as training data set (in particular on a volatile and/or non-volatile storage device). A plurality of training data sets are preferably generated in this way.

The classification feature(s) is/are in particular framework conditions such as a desired container volume, a starting material of the plastic container, a design requirement for a container to be manufactured, geometric dimensions of a plastic preform, a liquid to be filled, or the like.

It is also conceivable that the image evaluation model and/or the machine learning model be/will only be trained to recognize some of the aforementioned genera/species of the containers to be manufactured.

It is also conceivable that the image evaluation model and/or the machine learning model be trained only to recognize specific target specifications - for example, a specific starting material for the plastic preforms or a specific beverage to be filled.

However, as mentioned above, several of these steps can also be performed by the machine learning model.

By using an image evaluation model of machine learning and/or a machine-learning learning model, it is possible to identify or determine an optimal (complex) combination of different features for data processing, as well as features (or feature combinations) adapted to a wide variety of different design requirements or target specifications of the containers or initial values (such as a material).

In a preferred method, the plastic containers are plastic containers which are manufactured by a blow-molding method and in particular by a stretch blow-molding method, in particular from heated plastic preforms. It is known that plastic preforms are first heated, and these are then formed into plastic containers within a blow mold and, in particular, are blown.

This means that the aforementioned blow molds already form a negative of these plastic containers. The design of containers also includes, in particular, the design of the corresponding molds, e.g., blow molds, which are suitable and intended for manufacturing said containers.

However, as mentioned above, the plastic containers may also be plastic preforms. It is known that these are manufactured using injection-molding methods.

In a further preferred method, such plastic containers are designed, which are manufactured from injection-molded plastic preforms.

In a further preferred method, a plurality of manufacturing parameters characteristic of a manufacturing method for manufacturing the container to be designed are taken into account. This also allows the consideration of a plurality of manufacturing parameters characteristic of a manufacturing method for manufacturing plastic preforms.

Preferably, at least some of these manufacturing parameters are provided to this artificial intelligence as second training data or as a second training data set.

Particularly preferably, at least some of the physical parameters and/or at least some of the manufacturing parameters be determined using already manufactured plastic containers. It should here be taken into account that the data for a manufacturing method and also the physical data of the plastic containers are usually known.

In a further preferred method, a machine learning model is created using some of the physical parameters, and preferably all of the physical parameters.

Preferably, this machine learning model is provided to the artificial intelligence and/or used by the artificial intelligence.

The aforementioned machine learning model is particularly preferably created using both some of the physical parameters and some of the manufacturing parameters.

It would in this case be possible to use all data or data types as training data. However, it would also be possible that only a certain number of these data or only some of these data be used for the creation of specific container designs.

For example, if it is established that the containers will in future consist only of fresh, i.e., non-recycled, plastic material, it would be possible not to record certain data, such as data characteristic of a wall thickness distribution.

For example, if it is established that the containers to be manufactured are intended for being filled with a non-carbonated beverage, certain data relating to the embodiment of the container bottoms can be disregarded, and in particular, disregarded when creating the machine learning model.

In a further preferred method, the machine learning model is suitable and intended for determining a relationship between at least one of the physical parameters and preferably several physical parameters, and at least one manufacturing parameter and preferably several manufacturing parameters. However, it would also be conceivable that such a relationship be predetermined for the machine learning model.

Preferably, a plurality of such relationships are identified. This makes it possible, for example, to determine how a particular material of the plastic preforms affects the blow-molding process. It is also possible to determine how, for example, a specific bottom shape of the plastic container affects other physical properties such as its stability.

Preferably, an AI can be used to predict the performance of containers, wherein in particular the measurement data from previous designs, their simulation results and/or real result data, or problem cases and/or their solution data are taken into account.

This can in turn be analyzed in advance or during the design process, and the container designer can be given direct feedback and/or input on which parameters of the new container may need to be adjusted and how, so that the container has the necessary properties for processing.

In a further preferred method, this prediction of container qualities can be made, for example, by using regression algorithms and/or neural networks.

In a further preferred method, target specifications are taken into account and/or used as a basis for determining a desired shape of the container to be manufactured. This can also include, in particular, the customer's design wishes. Preferably, these target specifications are predetermined by a user or can be predetermined by a user.

For example, it can be predetermined what type of bottom is desired (e.g., a so-called champagne bottom or a bottom with standing feet) or what specific shape of a main body shall be achieved. For example, a customer requirement might be to imitate the shape of a particular container from the 1970's, or to retain as much of the same customer's design as possible.

In a preferred method, at least one physical parameter characteristic of a container to be designed is selected, and preferably several or the parameters characteristic of a container to be designed are selected from a group of parameters, which include a size of the container to be manufactured and/or designed, a shape of the container to be manufactured and/or designed, a cross-section of the container to be manufactured and/or designed, a cross-sectional profile of the container to be manufactured and/or designed, a material of the container to be manufactured and/or designed, a recycled content of the material of the container to be manufactured and/or designed, an internal volume of the container to be manufactured or designed, a wall thickness of the container to be manufactured or designed, a wall thickness distribution of the container to be manufactured or designed, a size of a plastic preform to be used for manufacturing the plastic container, a material of the plastic preform used to manufacture the plastic container, a recycled content of a material of the plastic preform used to manufacture the plastic container, a closure type of the plastic container to be manufactured or designed, a wall thickness of the plastic preform used to manufacture the plastic container to be designed, a shape of a mouth of the plastic container to be manufactured or designed, and the like.

In a further preferred method, at least one manufacturing parameter characteristic of the manufacturing method for manufacturing the container to be designed is selected from a group of manufacturing parameters that are characteristic of a manufacturing process for plastic preforms used to manufacture the plastic containers (to be designed).

This may include, in particular, a plastic granulate used or to be used, a manufacturing method, a temperature used for the manufacture of the plastic preforms, a temperature of the cavities, a pressure used for the manufacture of the plastic preforms such as an injection pressure, operating parameters of a plasticizing unit, or the like.

Furthermore, these may be manufacturing parameters that are characteristic of a heating process of the plastic preforms used to manufacture the plastic containers, such as in particular a heating temperature, a heating power, a type of heating device (for example, IR heating and/or microwave heating), a transport speed during heating, a temperature difference during heating, and the like.

Furthermore, it can be a parameter characteristic of a forming process (by which the plastic preforms are formed into the plastic containers).

In particular, this includes the blowing pressure used, the number of different pressure stages, the pressures of different pressure stages, the speed of a stretching bar movement, the movement profile of a stretching bar movement, the coordination between a stretching bar movement and a pressure application, the duration of the forming process, the inlet temperature of the plastic preforms before the forming process, the temperature profile of the plastic preforms in their longitudinal and/or circumferential direction, and the like.

In a further preferred method, at least one post-treatment parameter characteristic of a post-treatment process of a container to be designed and/or of a container to be manufactured is taken into account.

Particularly preferably, at least one, and preferably at least some, of these post-treatment parameters be made available to this artificial intelligence as third-party training data.

In a preferred method, the post-treatment parameters are selected from a group of post-treatment parameters which includes the type and/or quantity of a liquid to be filled into the container, the type and/or size of a label to be attached to the container, the position of a label to be attached to the container, the type and/or size of an imprint to be attached to the container, the position of an imprint to be affixed to the container, a sterilizing agent to be used for sterilizing the container, the type of a container closure to be attached to the container, a bottom shape of the container, a bottom cooling of the manufactured container, and the like.

In addition, the type of beverage or, in general, liquid to be discharged into the container can also be taken into account. Properties of this liquid, such as viscosity, carbonation, alcohol content, sugar content, color, its components, or the like, can be taken into account.

In a further preferred method, the artificial intelligence is used to predict properties of containers to be manufactured in the future or that have already been manufactured. Preferably, this prediction is based upon a machine learning model. For example, it is possible to predict what internal pressures the containers to be manufactured can withstand.

In a further preferred method the artificial intelligence is used to automate the design process.

In addition, communication with a designer or user may be possible or become possible during the design.

In a further preferred method, the artificial intelligence can, for example, communicate with a designer using natural language or text. Preferably, it is possible for the designer to be directly supported by the available information before or during the creation of container designs. This allows the AI to suggest specific design elements to a designer - for example, a specific bottom design for a container.

In addition, automation of design processes is preferred. For example, an AI can automate the creation of many design options by using general and generative design methods. Preferably, it can also evaluate design options based upon predetermined requirements and constraints.

In a further step, the AI (for example, using optimization algorithms) can also be used to independently optimize or improve the design of containers. In particular, the interactions of different parameters can be taken into account, e.g., determining how a certain wall thickness of the container affects the stability of its bottom.

In this way, certain goals can be achieved, such as a weight reduction, a material saving, or performance improvement, in particular by identifying potential weaknesses of the container in relation to future conditions.

In a preferred method, changes are made - in particular, automatically - to improve the container design accordingly.

For example, simulation algorithms can be used to simulate the stresses to which the container will be exposed. In this way, the effects upon the structure of the container can be assessed.

The present invention therefore allows for the consideration of different influencing factors upon the respective container design.

For example, it is possible to use the AI to predict the performance of containers. This allows data from previous designs to be analyzed, and the designer is preferably given feedback and/or input on which container parameters need to be and/or can be adapted, and preferably also on the effects of such adaptations.

Furthermore, a configuration step is preferably provided in which a user can configure a container of their choice. This configuration is also preferably used as an input variable when creating the machine learning model.

As mentioned, communication between the AI and the designer is also possible.

The AI can automate the design of design options, preferably using generative design methods. In a further step, the AI can also preferably optimize the design (as mentioned above - for example, to save upon weight and material or improve performance).

The present invention is further directed to a plastic container and in particular a beverage container or a plastic preform, wherein these plastic container is a blow-molded container or a plastic preform and in particular an injection-molded plastic preform. The container is or will be devised according to the invention by a method of the type described above.

The present invention further relates to a software, in particular a software stored on a data carrier, which is suitable and intended for carrying out a method of the type described above.

The present invention further relates to a data carrier with a software stored thereon, wherein the software is suitable for carrying out a method described above.

### Brief Description of the Drawings

The advantages and benefits can be found in the following description in conjunction with the drawing. In the drawing:

FIG. 1 shows a schematic representation for illustrating a method according to the invention.

FIG. 1 shows a schematic representation for illustrating a method according to the invention.

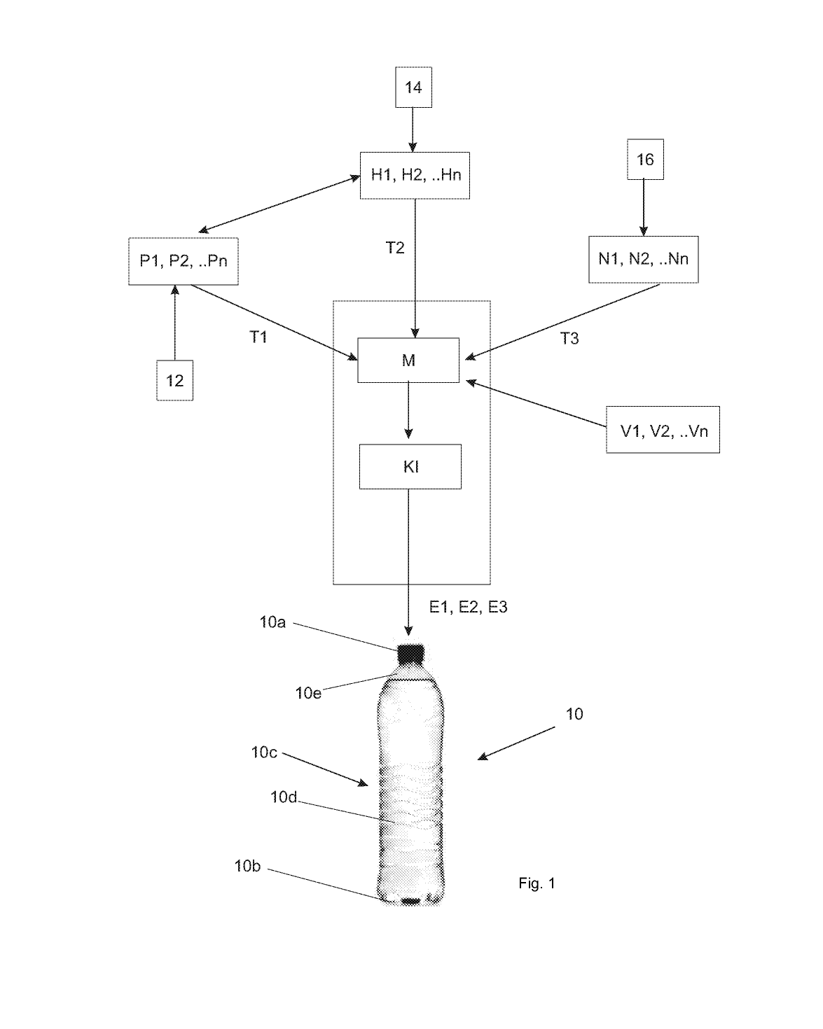

### Detail Description of the Drawings

The reference sign M denotes a model generation unit that is suitable and intended for generating a machine learning model based upon training data. The machine learning model created by the model generation unit is used by the artificial intelligence (AI) to output result data and/or result values E1, E2, E3 that are characteristic of a designed container.

An image of a designed container 10 can also be output. This container preferably has a bottom or bottom portion 10b and a closure 10a, which here is screwed onto a thread of the container.

The reference sign 10c denotes a main body of the container, which here has a plurality of reinforcing ribs 10d. Reference sign 10e identifies a shoulder region of the container.

The resulting values can, for example, be characteristic of the height of the designed container 10 or of its diameter. In addition, the number and/or shape of the reinforcement elements 10d can be specified as a result value.

It would also be possible for a user of the method to make further specifications, e.g., changing the number of reinforcement elements and/or their shape, and then the AI would interactively output new result values and possibly also a modified image of the designed container.

The reference signs P1, P2, …, Pn identify parameters characteristic of the container, which are supplied to the model generation unit as initial training data T1. Reference sign 12 denotes a measuring device by which these first parameters were recorded or captured.

It is possible for the recording of the physical parameters or the parameters characteristic of the container to be carried out in advance (i.e., not during production) using a or the measuring device mentioned here. It would therefore be conceivable that, prior to creating the design, physical parameters of a desired container could be recorded - for example, during a training run.

However, it would also be conceivable for these parameters to have already been determined in advance in other machines or other production runs (in particular in the same machine) and to have preferably been stored in a storage device.

Preferably, several measuring devices are provided, which preferably use existing containers to record the first parameters P1, P2, …, Pn. Such initial parameters could also be predetermined by a user, such as the height of containers or the shape of the bottom of these containers.

The reference signs H1, H2, …, Hn indicate manufacturing parameters that are characteristic of the method(s) used to manufacture plastic containers. Reference sign 14 denotes a storage device which is suitable and intended for storing such manufacturing parameters - for example, a pressure used in blow-molding. These parameters can be obtained, for example, through an operation of production facilities.

Preferably, the manufacturing parameters H1, H2, Hn and the container parameters are at least partially assigned to each other.

For example, a specific set of container parameters (e.g., material, container height, container wall thickness) can be assigned the manufacturing parameters with which that container was produced.

It would also be possible that the previously manufactured containers have a marking that allows for an identification of these containers and preferably also enables the determination of the manufacturing parameters with which this container was produced.

The reference signs N1, N2, …, Nn identify parameters characteristic of a post-treatment process of the container to be designed, such as the type and size of a label or imprint to be applied to the container, a liquid with which this container is to be filled, or the type of closure to be applied or that will be applied to this container.

A user interface 16 may be provided here, via which such data can be entered. However, it would also be conceivable that such information could be determined in the context of the manufacturing data.

In addition, a further user interface may be provided, through which specifications V1, V2, …, Vn can be predetermined, such as a desired internal volume of the container, a type of bottom of the container, a desired height, or a desired diameter. It would also be preferable to allow users to input images of a desired design as specifications - for example, based upon existing designs.

For example, it is possible to predetermine which well-known design the desired design should resemble.

The present invention is further directed to an apparatus for designing containers, and in particular plastic containers and in particular beverage containers, having a data processing device, wherein a plurality of physical parameters characteristic of a container to be designed can be supplied to these data processing device, and this data processing device is suitable and intended for taking these data into account in the design of the containers.

According to the invention, the data processing device is suitable and intended for carrying out a method for designing the containers and in particular a method as described above and for using an artificial intelligence (AI) for at least one method step of the method, wherein at least some of these physical parameters can be made available to this artificial intelligence (AI) as initial training data.

In a further preferred embodiment, the apparatus has a detection device for detecting data characteristic of (plastic) containers. Furthermore, the apparatus preferably has a detection device which is suitable and intended for detecting manufacturing parameters that are characteristic of the manufacture of plastic containers.

The data processing device is preferably configured, suitable, and/or intended for carrying out the method described above as well as all the method steps already described above in conjunction with the method, either individually or in combination with one another. Conversely, the method may be provided with all of the features described in the context of the data processing device, individually or in combination with one another.

The applicant reserves the right to claim all features disclosed in the application documents as essential to the invention, provided that they are novel over the prior art individually or in combination. It is further pointed out that features which may be advantageous in themselves are also described in the individual figures. A person skilled in the art will immediately recognize that a particular feature described in a figure may be advantageous even without the incorporation of further features from this figure. Furthermore, a person skilled in the art will recognize that advantages may also result from a combination of several features shown in individual or in different figures.

1. A method for designing containers, wherein a plurality of physical parameters characteristic of a container to be designed are taken into account,
wherein
an artificial intelligence is used for at least one method step of the method, wherein at least some of these physical parameters are provided to this artificial intelligence as initial training data.

2. The method according to claim 1,
wherein
the containers are those containers which are manufactured using a blow-molding method.

3. The method according to claim 1,
wherein
result data are output that are characteristic of a designed design.

4. The method according to claim 1,
wherein
a plurality of manufacturing parameters characteristic of a manufacturing method for manufacturing the container to be designed are taken into account.

5. The method according to claim 1,
wherein
the determination of at least some of the physical parameters and/or at least some of the manufacturing parameters is carried out using already manufactured plastic containers.

6. The method according to claim 1,
wherein
a machine learning model is created based upon at least some of the physical parameters and/or at least some of the manufacturing parameters.

7. The method according to claim 6,
wherein
the machine learning model is configured for determining and/or predicting a relationship between at least one physical parameter and at least one manufacturing parameter.

8. The method according to claim 7,
wherein
the prediction is or can be made using regression algorithms and/or neural networks.

9. The method according to claim 1,
wherein
target specifications are taken into account and/or used as a basis for determining a desired shape of the container to be manufactured.

10. The method according to claim 1,
wherein
at least one physical parameter characteristic of a container to be designed is selected from a group of parameters consisting of a size of the container to be manufactured, a shape of the container to be manufactured, a cross-section of a container to be manufactured, a material of the container to be manufactured, a recycled content of the material of the container to be manufactured, an internal volume of the container to be manufactured, a wall thickness of the container to be manufactured, a size of a plastic preform to be used for the manufacture of the plastic container, a material used for the manufacture of the plastic preform, a recycled content of a material of the plastic preform used for the manufacture of the plastic container, a closure type of the plastic container to be manufactured, a wall thickness of the plastic preform used for the manufacture of the plastic container, and a shape of a mouth of the plastic container to be manufactured.

11. The method according to claim 4,
wherein
at least one manufacturing parameter characteristic of the manufacturing method for manufacturing the container to be designed is selected from a group of manufacturing parameters which are characteristic of a manufacturing process for plastic preforms used to manufacture the plastic containers, and/or which is characteristic of a heating process of the plastic preforms used to manufacture the plastic containers, and/or which is characteristic of a forming process by which plastic preforms are formed into the plastic containers.

12. The method according to claim 1,
wherein
at least one post-treatment parameter characteristic of a post-treatment process of a container to be designed and/or a container to be manufactured is taken into account.

13. The method according to claim 12,
wherein
the at least one post-treatment parameter is selected from a group of post-treatment parameters consisting of the type and/or quantity of a liquid to be filled into the container, the type and/or size of a label to be attached to the container, the type of imprint to be attached to the container, a sterilizing agent to be used to sterilize the container, the type of container closure to be attached to the container, and a bottom cooling of a manufactured container.

14. The method according to claim 1,
wherein
the artificial intelligence is used to predict properties of future manufactured containers and/or to automate the design process and/or to enable communication with the designer during the design process.

15. A plastic container,
designed by a method according to claim 1.

16. An apparatus for designing containers, having a data processing device wherein a plurality of physical parameters characteristic of a container to be designed are supplied to this data processing device, and this data processing device is configured for taking these data into account in the design of the containers,
wherein
the data processing device is configured for carrying out a method for designing the containers and for employing an artificial intelligence for at least one method step of the method, wherein at least some of these physical parameters are made available to this artificial intelligence as initial training data.
